(19) United States
(12) Patent Application Publication
(10) Pub. No.: US 2018/0204405 A1
(43) Pub. Date: Jul. 19, 2018

(54) DETECTION METHOD AND APPARATUS FOR OVERLAPPED NOTES

(71) Applicant: GRG Banking Equipment Co., Ltd., Guangzhou, Guangdong (CN)

(72) Inventors: Xinhua Qiu, Guangzhou, Guangdong (CH); Mengtao Liu, Guangzhou, Guangdong (CN); Rongqiu Wang, Guangzhou, Guangdong (CN); Yuanchao Yu, Guangzhou, Guangdong (CN); Weifeng Wang, Guangzhou, Guangdong (CN)

(73) Assignee: GRG Banking Equipment Co., Ltd., Guangzhou, Guangdong (CN)

(21) Appl. No.: 15/757,971

(22) PCT Filed: Apr. 29, 2016
(86) PCT No.: PCT/CN2016/080650

§ 371 Date: Mar. 6, 2018

(30) Foreign Application Priority Data
Sep. 17, 2015 (CN) 201510594951.0

(51) Int. Cl. G07D 11/00; B65H 7/14; G06T 7/40

(52) U.S. Cl. CPC G07D 11/0039; B65H 7/14; B65H 2701/1912; G07D 2211/00; G06T 7/40

(57) ABSTRACT

An overlapping bill detection method and apparatus are provided. The method includes: collecting front images and back images of banknotes to be recognized, and transmission images, acquiring front banknote information and back banknote information of the banknotes to be recognized based on the front images and the back images, initializing a local feature attribute window, where the local feature attribute window is a template of a predetermined recognition region containing a feature attribute of an image to be recognized, measuring a coupling degree of the transmission images of the front images and the back images according to the local feature attribute window to obtain a measurement result, determining whether the measurement result meets a preset banknote overlapping condition, if so, determining that the banknotes to be recognized are overlapped, and otherwise, determining that the banknotes to be recognized are not overlapped

The present application claims priority to Chinese Patent Application No. 201510594951.0, titled “DETECTION METHOD AND APPARATUS FOR OVERLAPPED NOTES”, filed on Sep. 17, 2015 with the State Intellectual Property Office of People's Republic of China, which is incorporated herein by reference in its entirety.

### FIELD

The present disclosure relates to the field of financial devices, and in particular to an overlapping bill detection method and an overlapping bill detection device.

### BACKGROUND

An overlapping banknote detection capability is an important technical indicator for recognition capabilities of an intelligent banknote detector and a sorter. During banknote counting, banknotes are sometimes overlapped. Although the probability of overlapping banknotes can be reduced by improving a hardware structure, it is impossible to completely prevent the overlapping banknotes. Therefore, it is significant in banknote recognition to accurately detect whether the banknotes are overlapped.

At present, a general overlapping banknote detection method is based on a thickness signal. In the method, a thickness signal of each banknote in a banknote conveying passage is acquired by a thickness sensor, it is determined whether the banknotes are overlapped by determining whether the width and the thickness of the banknote are greater than given thresholds. In the method, high density and accuracy of signals acquired by the thickness sensor are required. The banknote may be erroneously determined as an overlapping banknote in the following cases: the banknote has an attachment (such as being adhered with an adhesive tape), the banknote arcs slightly and the banknote is old and becomes thick.

### SUMMARY

An overlapping bill detection method and an overlapping bill detection device are provided according to embodiments of the present disclosure. With the method and the device, it is solved a problem in existing overlapping bill detection methods that an erroneous determination is caused in the following cases: the banknote has an attachment, the banknote arcs slightly and the banknote is old and becomes thick.

An overlapping bill detection method is provided according to an embodiment of the present disclosure. The method includes:
acquiring front images and back images of to-be-recognized banknotes and transmission images of the front images or the back images;
acquiring front banknote information and back banknote information of the to-be-recognized banknotes based on the front images and the back images and initializing a corresponding local feature attribute window, where the local feature attribute window is a template of a predetermined recognition region containing a feature attribute of a to-be-recognized image;
measuring a coupling degree of the transmission images based on the local feature attribute window to obtain a measurement result; and
determining whether the measurement result meets a preset banknote overlapping condition, determining that the to-be-recognized banknotes are overlapped if the measurement result meets the preset banknote overlapping condition, and determining that the to-be-recognized banknotes are not overlapped if the measurement result does not meet the preset banknote overlapping condition.

Optionally, the step of measuring the coupling degree of the transmission images of the front images and the back images based on the local feature attribute window to obtain the measurement result includes at least one of a first sub-step, a second sub-step and a third sub-step.

The first subs-step includes:
calculating a tone texture period and a structure texture period corresponding to a region of the transmission image defined by the local feature attribute window, where the tone texture period includes the number of periodical color textures, the number of periods and a length of the period, and the structure texture period includes the number of periodical structure texture features, the number of periods and a length of the period; and
determining whether a difference between the tone texture period and a preset standard value corresponding to the local feature attribute window exceeds a first preset threshold and whether a difference between the structure texture period and the preset standard value corresponding to the local feature attribute window exceeds the first preset threshold, to obtain a first determination result.
The second sub-step includes:
acquiring a texton corresponding to the region of the transmission image defined by the local feature attribute window, where the texton is a texture unit having a specific shape; and
determining whether a difference between the texton and a predetermined standard texton corresponding to the local feature attribute window exceeds a second preset threshold, to obtain a second determination result.
The third sub-step includes:
calculating a texture definition corresponding to the region of the transmission image defined by the local feature attribute window, where the texture definition indicates a blurring degree of a predetermined texture; and
determining whether a difference between the texture definition and a preset standard value corresponding to the local feature attribute window exceeds a third preset threshold, to obtain a third determination result.

Optionally, the determining whether the measurement result meets the preset banknote overlapping condition includes:
determining whether any one of the first determination result, the second determination result and the third determination result is positive.

Optionally, before the determining whether any one of the first determination result, the second determination result and the third determination result is positive, the method further includes:
acquiring front denomination and orientation information of the to-be-recognized banknotes based on the front images;
acquiring back denomination and orientation information of the to-be-recognized banknotes based on the back images; and
determining whether the front denomination and orientation information is matched with the back denomination and orientation information according to a preset denomination and orientation rule, to obtain a fourth determination result.

Optionally, before the determining whether any one of the first determination result, the second determination result and the third determination result is positive, the method further includes:
acquiring front image sizes of the to-be-recognized banknotes based on the front images;
acquiring back image sizes of the to-be-recognized banknotes based on the back images; and
determining whether the front image sizes or the back image sizes go beyond a preset standard size range of the to-be-recognized banknotes, to obtain a fifth determination result.

Optionally, before the determining whether any one of the first determination result, the second determination result and the third determination result is positive, the method further includes:
acquiring front light-transmittances of the to-be-recognized banknotes based on the front images;
acquiring back light-transmittances of the to-be-recognized banknotes based on the back images; and
determining whether the front light-transmittances or the back light-transmittances go beyond a preset standard light-transmittance range of the to-be-recognized banknotes, to obtain a sixth determination result.

An overlapping bill detection device is provided according to an embodiment of the present disclosure. The device includes:
a front and back acquisition module configured to acquire front images and back images of to-be-recognized banknotes;
a banknote information acquisition module configured to acquire front banknote information and back banknote information of the to-be-recognized banknotes based on the front images and the back images and initialize a corresponding local feature attribute window, where the local feature attribute window is a template of a predetermined recognition region containing a feature attribute of a to-be-recognized image;
a coupling degree measurement module configured to measure a coupling degree of transmission images of the front images and the back images based on the local feature attribute window to obtain a measurement result;
an overlapping banknote determination module configured to determine whether the measurement result meets a preset banknote overlapping condition;
an overlapping banknote module configured to determine that the to-be-recognized banknotes are overlapped if it is determined by the overlapping banknote determination module that the measurement result meets the preset banknote overlapping condition; and
a non-overlapping banknote module configured to determine that the to-be-recognized banknotes are not overlapped if it is determined by the overlapping banknote determination module that the measurement result does not meet the preset banknote overlapping condition.

Optionally, the coupling degree measurement module includes at least one of a first sub-module, a second sub-module and a third sub-module.
The first sub-module includes:
a tone and structure texture unit configured to calculate a tone texture period and a structure texture period corresponding to a region of the transmission image defined by the local feature attribute window, where the tone texture period includes the number of periodical color textures, the number of periods and a length of the period, and the structure texture period includes the number of periodical structure texture features, the number of periods and a length of the period; and
a first determination unit configured to determine whether a difference between the tone texture period and a preset standard value corresponding to the local feature attribute window exceeds a first preset threshold and whether a difference between the structure texture period and the preset standard value corresponding to the local feature attribute window exceeds the first preset threshold, to obtain a first determination result.
The second sub-module includes:
a texton acquisition unit configured to acquire a texton corresponding to the region of the transmission image defined by the local feature attribute window, where the texton is a texture unit having a specific shape; and
a second determination unit configured to determine whether a difference between the texton and a predetermined standard texton corresponding to the local feature attribute window exceeds a second preset threshold, to obtain a second determination result.
The third sub-module includes:
a texture definition acquisition unit configured to calculate a texture definition corresponding to the region of the transmission image defined by the local feature attribute window, where the texture definition indicates a blurring degree of a predetermined texture; and
a third determination unit configured to determine whether a difference between the texture definition and a preset standard value corresponding to the local feature attribute window exceeds a third preset threshold, to obtain a third determination result.

Optionally, the overlapping banknote determination module includes:
an overlapping banknote determination unit configured to determine whether any one of the first determination result, the second determination result and the third determination result is positive.

Optionally, the device further includes at least one of a first module group, a second module group and a third module group.
The first module group includes:
a front information module configured to acquire front denomination and orientation information of the to-be-recognized banknotes based on the front images;
a back information module configured to acquire back denomination and orientation information of the to-be-recognized banknotes based on the back images; and
a denomination and orientation determination module configured to determine whether the front denomination and orientation information is matched with the back denomination and orientation information according to a preset denomination and orientation rule, to obtain a fourth determination result.
The second module group includes:
a front size module configured to acquire front image sizes of the to-be-recognized banknotes based on the front images;
a back size module configured to acquire back image sizes of the to-be-recognized banknotes based on the back images; and
an image size determination module configured to determine whether the front image sizes or the back image sizes go beyond a preset standard size range of the to-be-recognized banknotes, to obtain a fifth determination result.
The third module group includes:
a front light-transmittance module configured to acquire front light-transmittances of the to-be-recognized banknotes based on the front images;
a back light-transmittance module configured to acquire back light-transmittances of the to-be-recognized banknotes based on the back images; and
a light-transmittance determination module configured to determine whether the front light-transmittances or the back light-transmittances go beyond a preset standard light-transmittance range of the to-be-recognized banknotes, to obtain a sixth determination result.

It can be seen from the above technical solutions that, the embodiments of the present disclosure have the following advantages.

In the overlapping bill detection method according to the embodiments of the present disclosure, the coupling degree of the transmission images of the front images or the back images of the to-be-recognized banknotes is measured, and it is determined whether the banknotes are overlapped based on the measurement result. In this way, it is solved the problem in the existing overlapping bill detection methods that an erroneous determination is caused in the following cases: the banknote has an attachment, the banknote arcs slightly and the banknote is old and becomes thick.

### BRIEF DESCRIPTION OF THE DRAWINGS

FIG. 1 is a flowchart of an overlapping bill detection method according to an embodiment of the present disclosure;

FIG. 2 is a flowchart of an overlapping bill detection method according to another embodiment of the present disclosure;

FIGS. 3a and 3b are schematic diagrams showing a correct denomination and orientation combination according to an embodiment of the present disclosure;

FIGS. 4a and 4b are schematic diagrams showing a denomination and orientation combination of overlapping banknotes according to an embodiment of the present disclosure;

FIGS. 5a and 5b are schematic diagrams showing a denomination and orientation combination of overlapping banknotes according to an embodiment of the present disclosure;

FIGS. 6a and 6b are schematic diagrams showing overlapping banknote sizes according to an embodiment of the present disclosure;

FIG. 7 is a schematic diagram showing a comparison in a tone texture period according to an embodiment of the present disclosure;

FIGS. 8a and 8b are schematic diagrams showing a comparison in a structure texture period according to an embodiment of the present disclosure;

FIGS. 9a and 9b are schematic diagrams showing a comparison in a texton according to an embodiment of the present disclosure;

FIGS. 10a and 10b are schematic diagrams showing a comparison in a texture definition according to an embodiment of the present disclosure;

FIG. 11 is a structural diagram of an overlapping bill detection device according to an embodiment of the present disclosure; and

FIG. 12 is a structural diagram of an overlapping bill detection device according to another embodiment of the present disclosure.

### DETAILED DESCRIPTION OF EMBODIMENTS

An overlapping bill detection method and an overlapping bill detection device are provided according to embodiments of the present disclosure. With the method and the device, it is solved the problem in the existing overlapping bill detection methods that an erroneous determination is caused in the following cases: the banknote has an attachment, the banknote arcs slightly and the banknote is old and becomes thick.

In order to make the objectives, features and advantages of the present disclosure more apparent and easier to be understood, the technical solutions according to the embodiments of the present disclosure will be described clearly and completely as follows in conjunction with the drawings in the embodiments of the present disclosure. It is apparent that the described embodiments are only a few rather than all of the embodiments according to the present disclosure. Any other embodiments obtained by those skilled in the art based on the embodiments in the present disclosure without any creative work fall in the protection scope of the present disclosure.

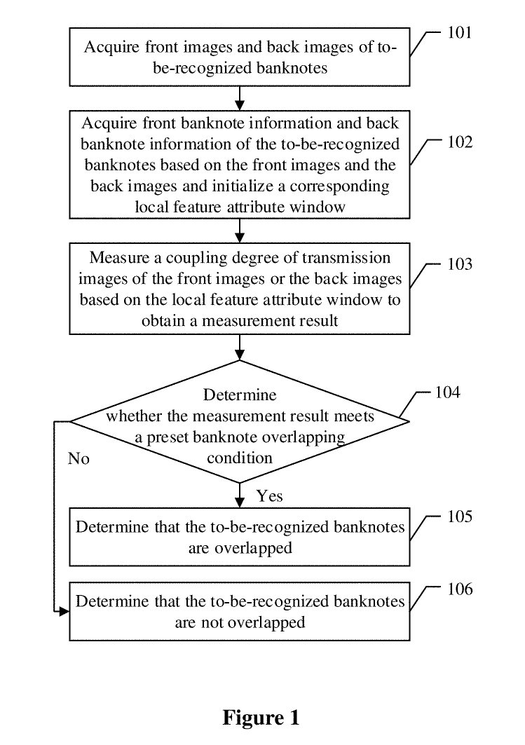

Referring to FIG. 1, an overlapping bill detection method according to an embodiment of the present disclosure includes steps 101 to 106.

In step 101, front images and back images of to-be-recognized banknotes and transmission images of the front images or the back images are acquired.

Firstly, the front images and the back images of the to-be-recognized banknotes and the transmission images of the front images or the back images may be acquired.

In step 102, front banknote information and back banknote information of the to-be-recognized banknotes are acquired based on the front images and the back images, and a corresponding local feature attribute window is initialized.

After the front images and the back images of the to-be-recognized banknotes are acquired, the front banknote information and back banknote information of the to-be-recognized banknotes may be acquired based on the front images and the back images, and the corresponding local feature attribute window is initialized. The local feature attribute window is a template of a predetermined recognition region containing a feature attribute of a to-be-recognized image.

In step 103, a coupling degree of the transmission images is measured based on the local feature attribute window to obtain a measurement result.

After the local feature attribute window is initialized, the coupling degree of the transmission images of the front images or the back images may be measured based on the local feature attribute window, to obtain the measurement result.

In step 104, it is determined whether the measurement result meets a preset banknote overlapping condition. Step 105 is performed if the measurement result meets the preset banknote overlapping condition, and step 106 is performed if the measurement result does not meet the preset banknote overlapping condition.

After the measurement result is obtained, it may be determined whether the measurement result meets the preset banknote overlapping condition. Step 105 is performed if the measurement result meets the preset banknote overlapping condition, and step 106 is performed if the measurement result does not meet the preset banknote overlapping condition.

In step 105, it is determined that the to-be-recognized banknotes are overlapped.

The to-be-recognized banknotes may be determined to be overlapped if the measurement result meets the preset banknote overlapping condition.

In step 106, it is determined that the to-be-recognized banknotes are not overlapped.

The to-be-recognized banknotes may be determined not to be overlapped if the measurement result does not meet the preset banknote overlapping condition.

In the embodiment, the aforementioned overlapping bill detection method includes the following steps. Firstly, the front images and the back images of the to-be-recognized banknotes, and the transmission images of the front images or the back images are acquired. Next, the front banknote information and the back banknote information of the to-be-recognized banknotes are acquired based on the front images and the back images, and the corresponding local feature attribute window is initialized. The local feature attribute window is a template of a predetermined recognition region containing a feature attribute of the to-be-recognized image. Then, the coupling degree of the transmission images is measured based on the local feature attribute window to obtain a measurement result. Finally, it is determined whether the measurement result meets the preset banknote overlapping condition. If the measurement result meets the preset banknote overlapping condition, the to-be-recognized banknotes are overlapped. If the measurement result does not meet the preset banknote overlapping condition, the to-be-recognized banknotes are not overlapped. In the overlapping bill detection method according to the embodiment, the coupling degree of the transmission images of the front images or the back images of the to-be-recognized banknotes is measured and it is determined whether the to-be-recognized banknotes are overlapped based on the measurement result. In this case, it is solved the problem in the existing overlapping bill detection methods that an erroneous determination is caused in the following cases: the banknote has an attachment, the banknote arcs slightly and the banknote is old and becomes thick.

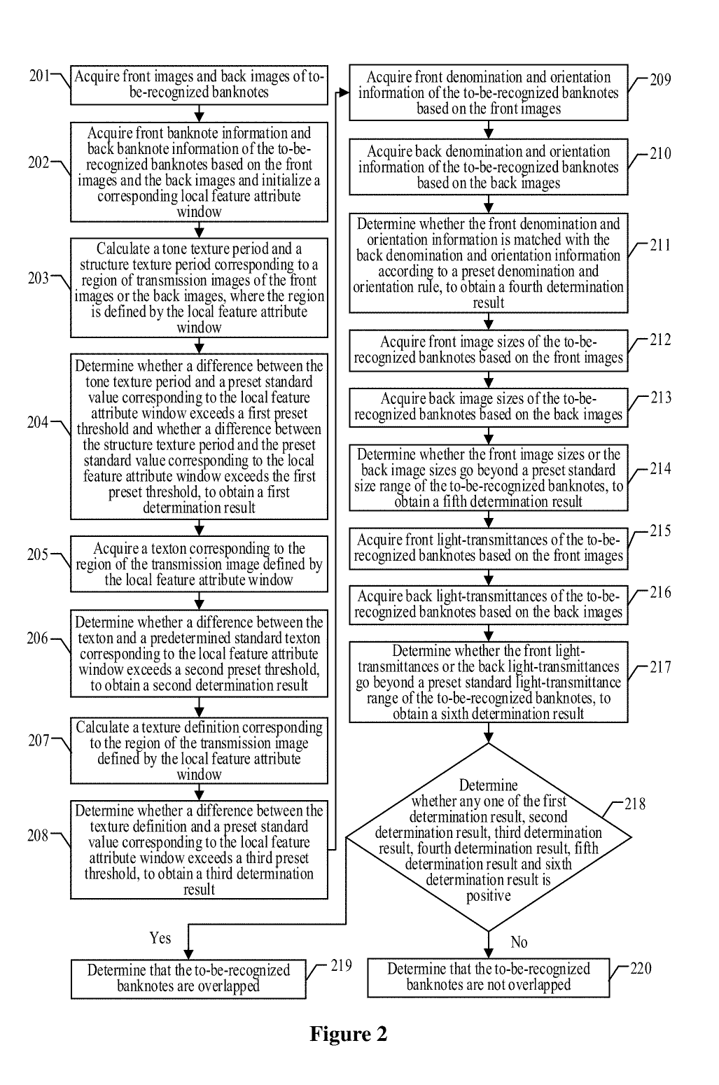

For facilitating understanding, an overlapping bill detection method according to an embodiment of the present disclosure is described in detail below. Referring to FIG. 2, an overlapping bill detection method according to another embodiment of the present disclosure includes steps 201 to 220.

In step 201, front images and back images of to-be-recognized banknotes and transmission images of the front images or the back images are acquired.

Firstly, the front images and the back images of the to-be-recognized banknotes and the transmission images of the front images or the back images are acquired.

In step 202, front banknote information and back banknote information of the to-be-recognized banknotes are acquired based on the front images and the back images, and a corresponding local feature attribute window is initialized.

After the front images and back images of the to-be-recognized banknotes are acquired, the front banknote information and back banknote information of the to-be-recognized banknotes may be acquired based on the front images and the back images, and the corresponding local feature attribute window is initialized. The local feature attribute window is a template of a predetermined recognition region containing a feature attribute of the to-be-recognized image.

It can be understood that, the local feature attribute window is predefined according to a rule that different banknotes correspond to different local feature attribute windows. The local feature attribute window is used for rapidly positioning, on the image of the banknote, a region for which specific feature information is to be acquired. Therefore, in the embodiment, the front banknote information and the back banknote information corresponding to the front images and the back images can be acquired. For example, if the banknote information is denomination, a local feature attribute window corresponding to the front image can be acquired, a local feature attribute window corresponding to the back image can be acquired, and these local feature attribute windows are initialized.

In step 203, a tone texture period and a structure texture period corresponding to a region of the transmission image of the front image or the back image are calculated, and the region is defined by the local feature attribute window.

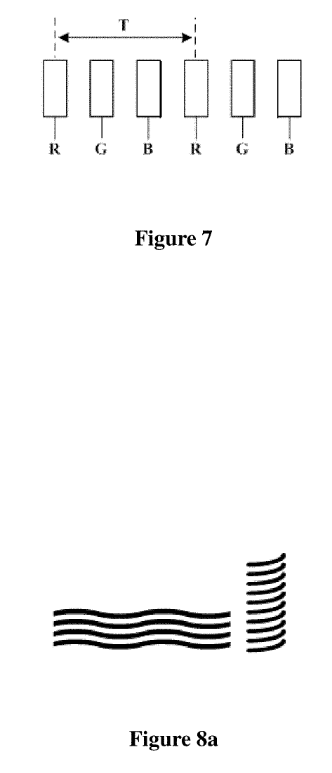

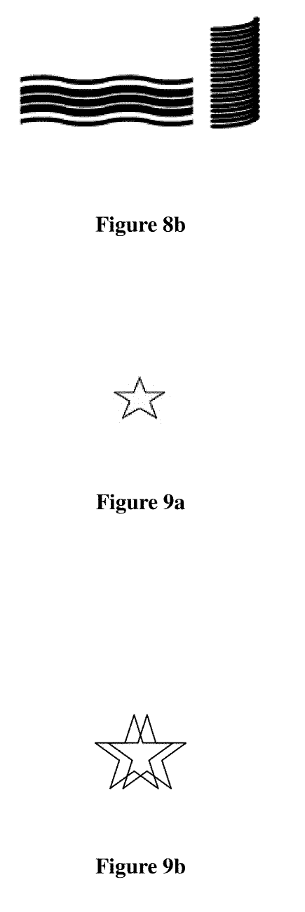

After the local feature attribute window is initialized, the tone texture period and the structure texture period corresponding to the region of the transmission image of the front image or the back image may be calculated, and the region is defined by the local feature attribute window. It can be understood that, the tone texture period includes the number of periodical color textures, the number of periods and a length of the period. As shown in FIG. 7, letters R, G and B respectively represent texture colors, the number of tone periodical textures is three, the number of periods is one and the length of the periods is T. The structure texture period includes the number of periodical structure texture features, the number of periods and a length of the period. As shown in FIG. 8a, the number of structure textures is two, the numbers of periods are respectively three and nine, and the lengths of the periods are respectively T₁ and T₂.

It should be noted that, two banknotes cannot seamlessly coincide with each other due to factors such as print accuracy, differences in mediums and sizes, and motion. Therefore, it can be determined whether the to-be-recognized banknotes re overlapped based on a difference between the tone texture period of the banknote and a standard value and a difference between the structure texture period of the banknote and the standard value. The process is described in detail in step 204.

In step 204, it is determined whether a difference between the tone texture period and a preset standard value corresponding to the local feature attribute window exceeds a first preset threshold and whether a difference between the structure texture period and the preset standard value corresponding to the local feature attribute window exceeds the first preset threshold, to obtain a first determination result.

After the tone texture period and the structure texture period corresponding to the region of the transmission image of the front image or the back image defined by the local feature attribute window are calculated, it may be determined whether the difference between the tone texture period and the preset standard value corresponding to the local feature attribute window exceeds the first preset threshold and whether the difference between the structure texture period and the preset standard value corresponding to the local feature attribute window exceeds the first preset threshold, to obtain the first determination result.

It can be understood that, the standard value corresponding to the local feature attribute window is preset. The standard value includes standard values of the tone texture period and the structure texture period. The difference between the tone texture period and the standard value and the difference between the structure texture period and the standard value are calculated. If the differences exceed the first preset threshold, it can be determined that the tone texture period and the structure texture period of the to-be-recognized image are not in a normal range, and the to-be-recognized image is determined to be overlapping banknotes. For example, FIG. 8a shows a standard texture, FIG. 8b shows a texture in the case of two overlapping banknotes, and it can be seen that a large difference exists between the period in FIG. 8b and the standard value.

In step 205, a texton corresponding to the region of the transmission image defined by the local feature attribute window is acquired.

After the local feature attribute window is initialized, the texton corresponding to the region of the transmission image defined by the local feature attribute window may be acquired. The texton has a specific shape, as shown in FIG. 9a. It can be understood that, a texton corresponding to a region can be easily obtained from the transmission image by means of the local feature attribute window.

In step 206, it is determined whether a difference between the texton and a predetermined standard texton corresponding to the local feature attribute window exceeds a second preset threshold, to obtain a second determination result.

After the texton corresponding to the region of the transmission image defined by the local feature attribute window is acquired, it may be determined whether the difference between the texton and the predetermined standard texton corresponding to the local feature attribute window exceeds the second preset threshold to obtain the second determination result.

It can be understood that, the standard texton corresponding to the local feature attribute window is preset, and is a standard template (or numeric value) for a texton. A difference is obtained by comparing the texton with the standard texton. If the difference exceeds the second preset threshold, it can be determined that the texton of the to-be-recognized image is not in a normal range and the to-be-recognized image is overlapping banknotes. For example, FIG. 9a shows a standard texture template and the texton in the transmission image may become a texture shown in FIG. 9b in the case of overlapping banknotes.

In step 207, a texture definition corresponding to the region of the transmission image defined by the local feature attribute window is calculated.

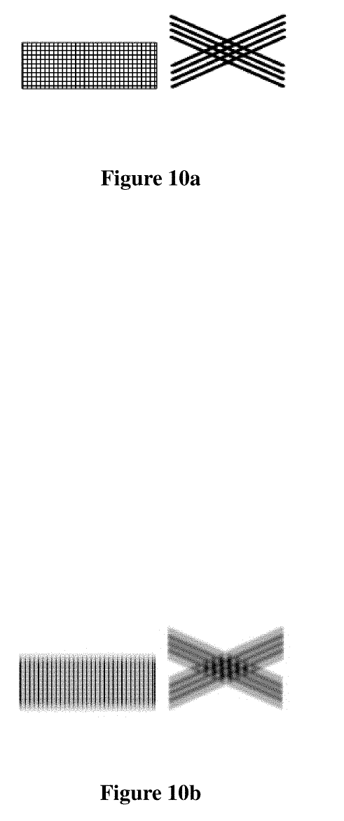

After the local feature attribute window is initialized, the texture definition corresponding to the region of the transmission image defined by the local feature attribute window may be calculated. The texture definition indicates a blurring degree of a predetermined texture, as shown in FIG. 10a. It may be understood that, the probability of the occurrence of banknote overlapping is greater as the blurring degree is higher. Conversely, the probability of the occurrence of banknote overlapping is less as the blurring degree is lower.

In step 208, it is determined whether a difference between the texture definition and a preset standard value corresponding to the local feature attribute window exceeds a third preset threshold, to obtain a third determination result.

After the texture definition corresponding to the region of the transmission image defined by the local feature attribute window is calculated, it may be determined whether the difference between the texture definition and the preset standard value corresponding to the local feature attribute window exceeds the third preset threshold, to obtain the third determination result.

It may be understood that, the standard value corresponding to the local feature attribute window is preset. The standard value is a standard numeric value for a texture definition. The difference between the texture definition and the standard value is calculated. If the difference exceeds the third preset threshold, it can be determined that the texture definition of the to-be-recognized image is not in a normal range, and the to-be-recognized image is overlapping banknotes. For example, FIG. 10a shows a clear texture, and FIG. 10b shows a blurred texture in the case of overlapping banknotes.

In step 209, front denomination and orientation information of the to-be-recognized banknotes is acquired based on the front image.

After the front image is acquired, the front denomination and orientation information of the to-be-recognized banknotes may be acquired based on the front image. It should be noted that, the front denomination and orientation information includes the denomination and the orientation of the front image. The denomination indicates a currency value of the banknote while the orientation indicates an orientation of a front side of the to-be-recognized banknote (placed forward or reversely) when the front image is formed.

In step 210, back denomination and orientation information of the to-be-recognized banknotes is acquired based on the back images.

Similarly, after the front images are acquired, the back denomination and orientation information of the to-be-recognized banknotes may be acquired based on the back images.

In step 211, it is determined whether the front denomination and orientation information is matched with the back denomination and orientation information according to a preset denomination and orientation rule, to obtain a fourth determination result.

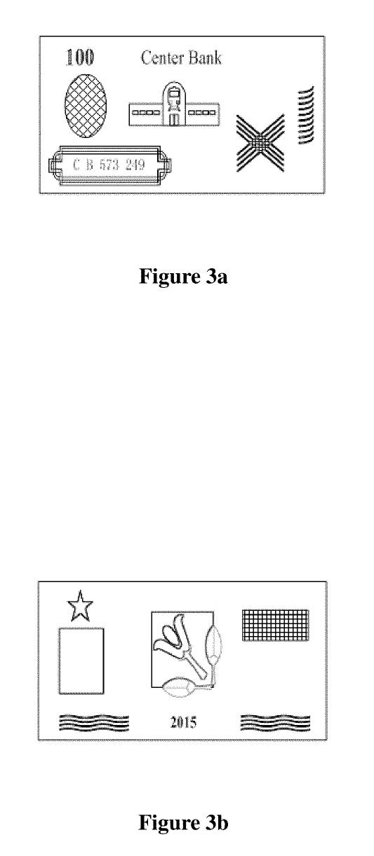

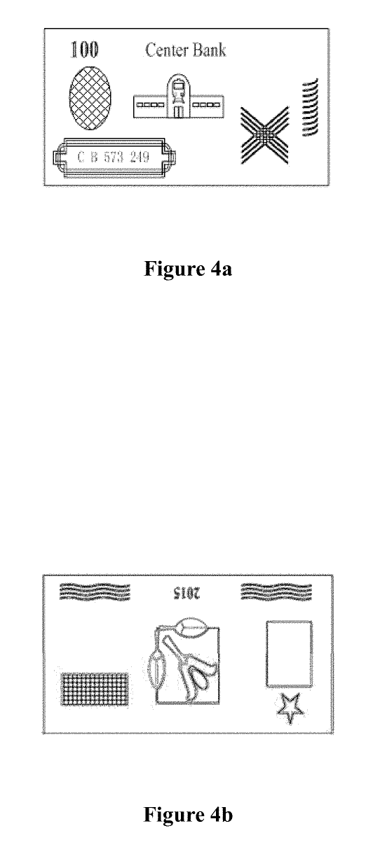

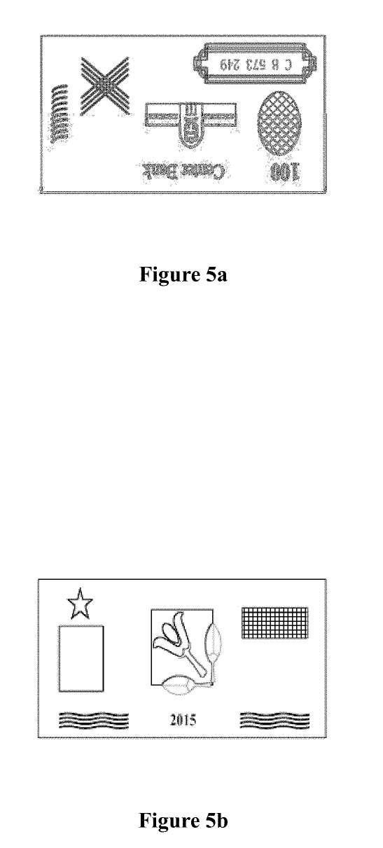

After the front denomination and orientation information and the back denomination and orientation information are acquired, it is determined whether the front denomination and orientation information is matched with the back denomination and orientation information according to the preset denomination and orientation rule, to obtain the fourth determination result. It can be understood that, if the front denomination and orientation information cannot be matched with the back denomination and orientation information according to prior knowledge, it is determined that the to-be-recognized banknotes are overlapped. For example, FIGS. 3a and 3b show a correct combination, and the above matching fails if combinations similar to that shown in FIGS. 4a and 4b and that shown in FIGS. 5a and 5b occur.

In step 212, front image sizes of the to-be-recognized banknotes are acquired based on the front images.

After the front images are acquired, the front image sizes of the to-be-recognized banknotes may be acquired based on the front images.

In step 213, back image sizes of the to-be-recognized banknotes are acquired based on the back images.

After the front images are acquired, the back image sizes of the to-be-recognized banknotes may be acquired based on the back images.

In step 214, it is determined whether the front image sizes or the back image sizes go beyond a preset standard size range of the to-be-recognized banknotes, to obtain a fifth determination result.

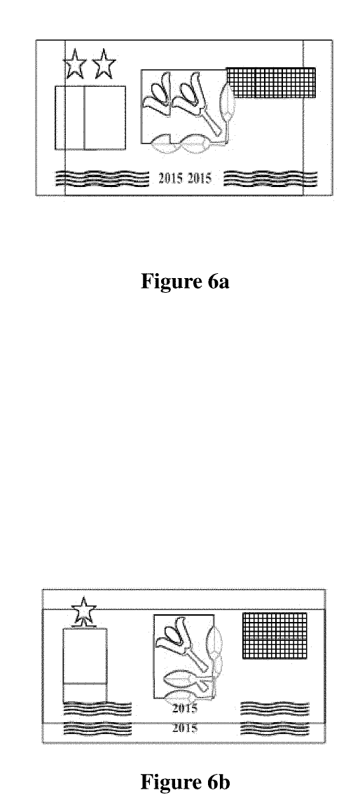

After the front image sizes and the back image sizes are acquired, it may be determined whether the front image sizes or the back image sizes go beyond the preset standard size range of the to-be-recognized banknotes, to obtain the fifth determination result. The front image sizes and the back image sizes include image height information and image width information. It can be understood that, as shown in FIGS. 6a and 6b, in the case that two banknotes are overlapped, i.e., are adhered in a misalignment manner, the acquired banknote sizes may go beyond the preset standard size range.

In step 215, front light-transmittances of the to-be-recognized banknotes are acquired based on the front images.

After the front images are acquired, the front light-transmittances of the to-be-recognized banknotes may be acquired based on the front images.

In step 216, back light-transmittances of the to-be-recognized banknotes are acquired based on the back images.

After the front images are acquired, the back light-transmittances of the to-be-recognized banknotes may be acquired based on the back images.

In step 217, it is determined whether the front light-transmittances or the back light-transmittances go beyond a preset standard light-transmittance range of the to-be-recognized banknotes, to obtain a sixth determination result.

After the front light-transmittances and the back light-transmittances are acquired, it may be determined whether the front light-transmittances or the back light-transmittances go beyond the preset standard light-transmittance range of the to-be-recognized banknotes, to obtain the sixth determination result.

It should be noted that, the light-transmittance includes a grayscale average value Gf of a reflection image, a grayscale average value Gt of a transmission image and a grayscale correlation Rft between the reflection image and the transmission image. Rft may be represented as a combination of Gf and Gt, as shown in equation (1). Gf and Gt may indicate a grayscale average value of an entire image, or may indicate a grayscale average value of a part of the image. For example, a grayscale average value of a watermark region in the case of overlapping banknotes may approach to a maximum value which is higher than a normal grayscale value by tens of grayscale levels. If the obtained light-transmittance goes beyond the preset standard light-transmittance range of the to-be-recognized banknotes, it is determined that the to-be-recognized banknotes are overlapped. The standard light-transmittance range is a preset standard range for the light-transmittance of the to-be-recognized banknotes.

R_{ft}=α(G_{f}/Gₜ)+β(G_{f}±Gₜ); (α∈R,β∈R) (1)

In which, α and β represent weight parameters, and R represents a real number domain.

In step 218, it is determined whether any one of the first determination result, second determination result, third determination result, fourth determination result, fifth determination result and sixth determination result is positive. Step 219 is performed if any one of the determination results is positive, and step 220 is performed if none of the determination results is positive.

After the above first determination result, second determination result, third determination result, fourth determination result, fifth determination result and sixth determination result are obtained, it may be determined whether any one of the determination results is positive. Step 219 is performed if any one of the determination results is positive, and step 220 is performed if none of the determination results is positive. That is to say, the to-be-recognized banknotes can be determined to be overlapped as long as one of the above first determination result, second determination result, third determination result, fourth determination result, fifth determination result and sixth determination result is positive. The to-be-recognized banknotes may be determined not to be overlapped if none of the determination results is negative.

In step 219, the to-be-recognized banknotes are determined to be overlapped.

The to-be-recognized banknotes are determined to be overlapped if any one of the above first determination result, second determination result, third determination result, fourth determination result, fifth determination result and sixth determination result is positive.

In step 220, the to-be-recognized banknotes are determined not to be overlapped.

The to-be-recognized banknotes are determined not to be overlapped if none of the above first determination result, second determination result, third determination result, fourth determination result, fifth determination result and sixth determination result is negative.

It should be noted that, the first determination result is acquired by steps 203 to 204, the second determination result is acquired by steps 205 to 206, the third determination result is acquired by steps 207 to 208, the fourth determination result is acquired by steps 209 to 211, the fifth determination result is acquired by steps 212 to 214, and the third determination result is acquired by steps 215 to 217. In this case, six modules may be provided. The overlapping bill can be detected by combining the six modules or by separately using the six modules. In addition, the six modules may be combined in an arbitrary order without affecting the result of overlapping banknote detection.

In the overlapping bill detection method according to the embodiment, the coupling degree of the transmission images of the front images or the back images of the to-be-recognized banknotes is measured, and it is determined whether the to-be-recognized banknotes are overlapped based on the measurement result. In this case, it is solved the problem in the existing overlapping bill detection methods that an erroneous determination is caused in the following cases: the banknote has an attachment, the banknote arcs slightly and the banknote is old and becomes thick.

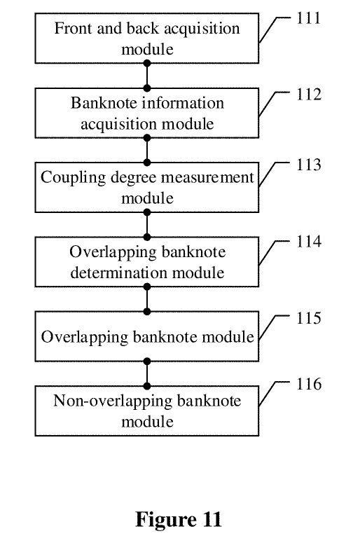

The overlapping bill detection method is described above, and an overlapping bill detection device is described in detail below. Reference is made to FIG. 11, and an overlapping bill detection device according to an embodiment of the present disclosure includes: a front and back acquisition module 111, a banknote information acquisition module 112, a coupling degree measurement module 113, an overlapping banknote determination module 114, an overlapping banknote module 115 and a non-overlapping banknote module 116.

The front and back acquisition module 111 is configured to acquire front images and back images of to-be-recognized banknotes.

The banknote information acquisition module 112 is configured to acquire front banknote information and back banknote information of the to-be-recognized banknotes based on the front images and the back images and initialize a corresponding local feature attribute window. The local feature attribute window is a template of a predetermined recognition region containing a feature attribute of a to-be-recognized image.

The coupling degree measurement module 113 is configured to measure a coupling degree of transmission images of the front images and the back images based on the local feature attribute window to obtain a measurement result.

The overlapping banknote determination module 114 is configured to determine whether the measurement result meets a preset banknote overlapping condition.

The overlapping banknote module 115 is configured to determine that the to-be-recognized banknotes are overlapped if it is determined by the overlapping banknote determination module 114 that the measurement result meets the preset banknote overlapping condition.

The non-overlapping banknote module 116 is configured to determine that the to-be-recognized banknotes are not overlapped if it is determined by the overlapping banknote determination module 114 that the measurement result does not meet the preset banknote overlapping condition.

In the embodiment, the front and back acquisition module 111 is configured to acquire the front images and the back images of the to-be-recognized banknotes. The banknote information acquisition module 112 is configured to acquire the front banknote information and the back banknote information of the to-be-recognized banknotes based on the front images and the back images and initialize a corresponding local feature attribute window. The local feature attribute window is a template of a predetermined recognition region containing a feature attribute of the to-be-recognized image. The coupling degree measurement module 113 is configured to measure the coupling degree of the transmission images of the front images and the back images based on the local feature attribute window to obtain the measurement result. The overlapping banknote determination module 114 is configured to determine whether the measurement result meets the preset banknote overlapping condition. The overlapping banknote module 115 is configured to determine that the to-be-recognized banknotes are overlapped if it is determined by the overlapping banknote determination module 114 that the measurement result meets the preset banknote overlapping condition. The non-overlapping banknote module 116 is configured to determine that the to-be-recognized banknotes are not overlapped if it is determined by the overlapping banknote determination module 114 that the measurement result does not meet the preset banknote overlapping condition. In the overlapping bill detection device according to the embodiment, the coupling degree of the transmission images of the front images or the back images of the to-be-recognized banknotes is measured, and it is determined whether the to-be-recognized banknotes are overlapped based on the measurement result. In this case, it is solved the problem in the existing overlapping bill detection methods that an erroneous determination is caused in the following cases: the banknote has an attachment, the banknote arcs slightly and the banknote is old and becomes thick.

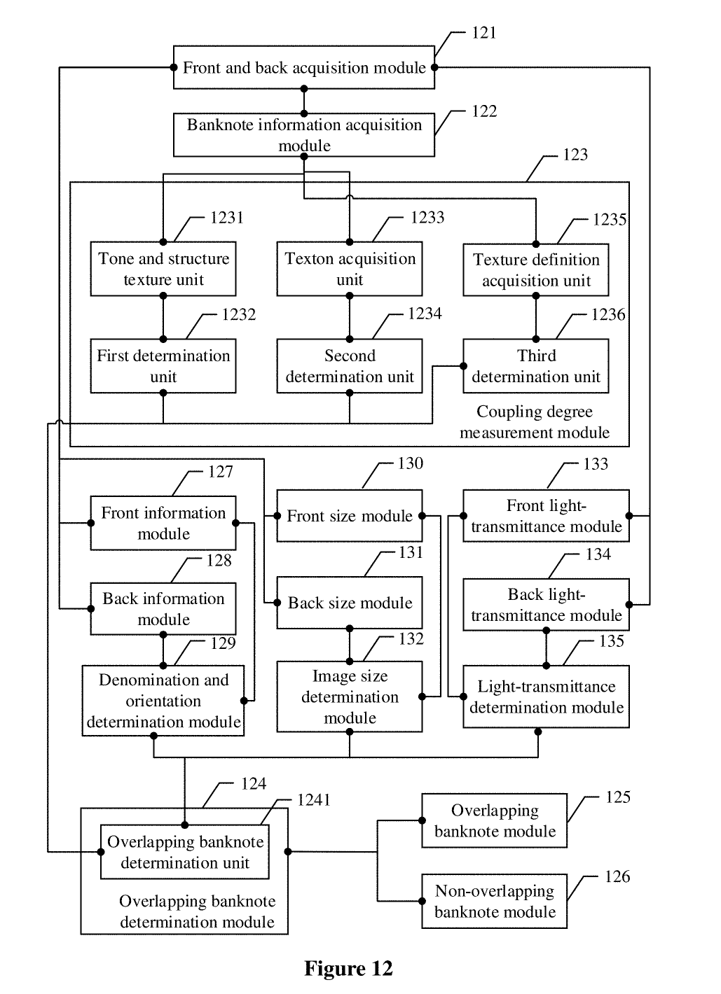

For facilitating understanding, an overlapping bill detection device according to an embodiment of the present disclosure is described in detail hereinafter. Referring to FIG. 12, the overlapping bill detection device according to another embodiment of the present disclosure includes: a front and back acquisition module 121, a banknote information acquisition module 122, a coupling degree measurement module 123, an overlapping banknote determination module 124, an overlapping banknote module 125 and a non-overlapping banknote module 126.

The front and back acquisition module 121 is configured to acquire front images and back images of to-be-recognized banknotes.

The banknote information acquisition module 122 is configured to acquire front banknote information and back banknote information of the to-be-recognized banknotes based on the front images and the back images and initialize a corresponding local feature attribute window. The local feature attribute window is a template of a predetermined recognition region containing a feature attribute of a to-be-recognized image.

The coupling degree measurement module 123 is configured to measure a coupling degree of transmission images of the front images and the back images based on the local feature attribute window to obtain a measurement result.

The overlapping banknote determination module 124 is configured to determine whether the measurement result meets a preset banknote overlapping condition.

The overlapping banknote module 125 is configured to determine that the to-be-recognized banknotes are overlapped if it is determined by the overlapping banknote determination module 124 that the measurement result meets the preset banknote overlapping condition.

The non-overlapping banknote module 126 is configured to determine that the to-be-recognized banknotes are not overlapped if it is determined by the overlapping banknote determination module 124 that the measurement result does not meet the preset banknote overlapping condition.

The coupling degree measurement module 123 according to the embodiment may include at least one of a first sub-module, a second sub-module and a third sub-module. The first sub-module includes a tone and structure texture unit 1231 and a first determination unit 1232. The second sub-module includes a texton acquisition unit 1233 and a second determination unit 1234. The third sub-module includes a texture definition acquisition unit 1235 and a third determination unit 1236.

The tone and structure texture unit 1231 is configured to calculate a tone texture period and a structure texture period corresponding to a region of the transmission image defined by the local feature attribute window. The tone texture period includes the number of periodical color textures, the number of periods and a length of the period. The structure texture period includes the number of periodical structure texture features, the number of periods and a length of the period.

The first determination unit 1232 is configured to determine whether a difference between the tone texture period and a preset standard value corresponding to the local feature attribute window exceeds a first preset threshold and whether a difference between the structure texture period and the preset standard value corresponding to the local feature attribute window exceeds the first preset threshold, to obtain a first determination result.

The texton acquisition unit 1233 is configured to acquire a texton corresponding to the region of the transmission image defined by the local feature attribute window. The texton is a texture unit having a specific shape.

The second determination unit 1234 is configured to determine whether a difference between the texton and a predetermined standard texton corresponding to the local feature attribute window exceeds a second preset threshold, to obtain a second determination result.

The texture definition acquisition unit 1235 is configured to calculate a texture definition corresponding to the region of the transmission image defined by the local feature attribute window. The texture definition indicates a blurring degree of a predetermined texture.

The third determination unit 1236 is configured to determine whether a difference between the texture definition and a preset standard value corresponding to the local feature attribute window exceeds a third preset threshold, to obtain a third determination result.

The overlapping banknote determination module 124 according to the embodiment includes an overlapping banknote determination unit 1241.

The overlapping banknote determination unit 1241 is configured to determine whether any one of the first determination result, the second determination result and the third determination result is positive.

The overlapping bill detection device according to the embodiment may further include at least one of a first module group, a second module group and a third module group. The first module group includes a front information module 127, a back information module 128 and a denomination and orientation determination module 129. The second module group includes a front size module 130, a back size module 131 and an image size determination module 132. The third module group includes a front light-transmittance module 133, a back light-transmittance module 134 and a light-transmittance determination module 135.

The front information module 127 is configured to acquire front denomination and orientation information of the to-be-recognized banknotes based on the front images.

The back information module 128 is configured to acquire back denomination and orientation information of the to-be-recognized banknotes based on the back images.

The denomination and orientation determination module 129 is configured to determine whether the front denomination and orientation information is matched with the back denomination and orientation information according to a preset denomination and orientation rule, to obtain a fourth determination result.

The front size module 130 is configured to acquire front image sizes of the to-be-recognized banknotes based on the front images.

The back size module 131 is configured to acquire back image sizes of the to-be-recognized banknotes based on the back images.

The image size determination module 132 is configured to determine whether the front image sizes or the back image sizes go beyond a preset standard size range of the to-be-recognized banknotes, to obtain a fifth determination result.

The front light-transmittance module 133 is configured to acquire front light-transmittances of the to-be-recognized banknotes based on the front images.

The back light-transmittance module 134 is configured to acquire back light-transmittances of the to-be-recognized banknotes based on the back images.

The light-transmittance determination module 135 is configured to determine whether the front light-transmittances or the back light-transmittances go beyond a preset standard light-transmittance range of the to-be-recognized banknotes, to obtain a sixth determination result.

It should be noted that, the first determination result is acquired by the above units 1231 and 1232, the second determination result is acquired by the above units 1233 and 1234, the third determination result is acquired by the above units 1235 and 1236, the fourth determination result is acquired by the above modules 127, 128 and 129, the fifth determination result is acquired by the above modules 130, 131 and 132, and the third determination result is acquired by the above modules 133, 134 and 135. Therefore, the above components may be grouped into six groups. The overlapping bills can be detected by combining the six groups or by using the six groups separately. In addition, the six groups may be combined in an arbitrary order, without affecting the result of overlapping banknote detection.

It may be clearly understood by those skilled in the art that, for ease of describing and for simplicity, for an operating process of the system, the device and the unit described above, one may refer to the process in the above method embodiment, which is not described herein any more.

In several embodiments according to the present disclosure, it should be understood that the disclosed system, device and method can be implemented in other ways. The device embodiments described above are merely schematic. For example, the division of the units is merely a logic functional division, and there may be other divisions in practice. For example, multiple units or components can be combined, or can be integrated into another system, or some features may be ignored, or not be executed. In addition, the coupling, direct coupling or communication connection between components which are shown or discussed may be indirect coupling or communication connection via some interfaces, devices or units, which may be electrical, mechanical, or in other form.

The units illustrated as separate components may be or may not be separated physically, and the component displayed as a unit may be or may not be a physical unit. That is, the components may be located at the same place, or may be distributed on multiple network units. Some or all of the units may be selected, as required, to realize the object of the solution of the embodiment.

In addition, function units according to embodiments of the present disclosure may be integrated into one processing unit, or the units are physically independent from each other, or two or more units are integrated into one unit. The integrated unit described above may be realized in a hardware way, or may be realized by a software function unit.

The integrated unit may be stored in a computer readable storage medium if the integrated unit is implemented in a software function unit and sold or used as an independent product. Base on such understanding, the essential part of the technical solution of the present disclosure or the part of the technical solution of the present disclosure contributing to the conventional technology or all or a part of the technical solution may be embodied as a software product. The computer software product is stored in a storage medium, which includes several instructions to make a computer device (which may be a personal computer, a server, a network device or the like) execute all or a part of steps of the method according to embodiments of the present disclosure. The storage medium described above includes various mediums which can store program codes, such as a USB disk, a mobile hard disk, a read-only memory (ROM), a random access memory (RAM), a disk and a compact disc.

In summary, the above embodiments are only for illustrating the technical solutions of the present disclosure, and are not intended to limit the present disclosure. The present disclosure is described in detail by referring to the aforementioned embodiments. It should be understood by those skilled in the art that, modifications can be made to the technical solutions described in the aforementioned embodiments, or equivalent replacements can be made to a portion of technical features of the technical solutions, as long as the modifications and equivalent replacements do not depart from the spirit and scope of the technical solutions according to the embodiments of the present disclosure.

1. An overlapping bill detection method, comprising:
acquiring front images and back images of to-be-recognized banknotes and transmission images of the front images or the back images;
acquiring front banknote information and back banknote information of the to-be-recognized banknotes based on the front images and the back images and initializing a corresponding local feature attribute window, wherein the local feature attribute window is a template of a predetermined recognition region containing a feature attribute of a to-be-recognized image;
measuring a coupling degree of the transmission images based on the local feature attribute window to obtain a measurement result; and
determining whether the measurement result meets a preset banknote overlapping condition, determining that the to-be-recognized banknotes are overlapped if the measurement result meets the preset banknote overlapping condition, and determining that the to-be-recognized banknotes are not overlapped if the measurement result does not meet the preset banknote overlapping condition.

2. The method according to claim 1, wherein the measuring the coupling degree of the transmission images of the front images or the back images based on the local feature attribute window to obtain the measurement result comprises at least one of the following sub-steps:
a first sub-step, comprising:
calculating a tone texture period and a structure texture period corresponding to a region of the transmission image defined by the local feature attribute window, wherein the tone texture period comprises the number of periodical color textures, the number of periods and a length of the period, and the structure texture period comprises the number of periodical structure texture features, the number of periods and a length of the period; and
determining whether a difference between the tone texture period and a preset standard value corresponding to the local feature attribute window exceeds a first preset threshold and whether a difference between the structure texture period and the preset standard value corresponding to the local feature attribute window exceeds the first preset threshold, to obtain a first determination result;
a second sub-step, comprising
acquiring a texton corresponding to the region of the transmission image defined by the local feature attribute window, wherein the texton is a texture unit having a specific shape; and
determining whether a difference between the texton and a predetermined standard texton corresponding to the local feature attribute window exceeds a second preset threshold, to obtain a second determination result; and
a third sub-step, comprising:
calculating a texture definition corresponding to the region of the transmission image defined by the local feature attribute window, wherein the texture definition indicates a blurring degree of a predetermined texture; and
determining whether a difference between the texture definition and a preset standard value corresponding to the local feature attribute window exceeds a third preset threshold, to obtain a third determination result.

3. The method according to claim 2, wherein the determining whether the measurement result meets the preset banknote overlapping condition comprises:
determining whether any one of the first determination result, the second determination result and the third determination result is positive.

4. The method according to claim 3, wherein before the determining whether any one of the first determination result, the second determination result and the third determination result is positive, the method further comprises:
acquiring front denomination and orientation information of the to-be-recognized banknotes based on the front images;
acquiring back denomination and orientation information of the to-be-recognized banknotes based on the back images; and
determining whether the front denomination and orientation information is matched with the back denomination and orientation information according to a preset denomination and orientation rule, to obtain a fourth determination result.

5. The method according to claim 3, wherein before the determining whether any one of the first determination result, the second determination result and the third determination result is positive, the method further comprises:
acquiring front image sizes of the to-be-recognized banknotes based on the front images;
acquiring back image sizes of the to-be-recognized banknotes based on the back images; and
determining whether the front image sizes or the back image sizes go beyond a preset standard size range of the to-be-recognized banknotes, to obtain a fifth determination result.

6. The method according to claim 3, wherein before the determining whether any one of the first determination result, the second determination result and the third determination result is positive, the method further comprises:
acquiring front light-transmittances of the to-be-recognized banknotes based on the front images;
acquiring back light-transmittances of the to-be-recognized banknotes based on the back images; and
determining whether the front light-transmittances or the back light-transmittances go beyond a preset standard light-transmittance range of the to-be-recognized banknotes, to obtain a sixth determination result.

7. An overlapping bill detection device, comprising:
a front and back acquisition module configured to acquire front images and back images of to-be-recognized banknotes;
a banknote information acquisition module configured to acquire front banknote information and back banknote information of the to-be-recognized banknotes based on the front images and the back images and initialize a corresponding local feature attribute window, wherein the local feature attribute window is a template of a predetermined recognition region containing a feature attribute of a to-be-recognized image;
a coupling degree measurement module configured to measure a coupling degree of transmission images of the front images or the back images based on the local feature attribute window to obtain a measurement result;
an overlapping banknote determination module configured to determine whether the measurement result meets a preset banknote overlapping condition;
an overlapping banknote module configured to determine that the to-be-recognized banknotes are overlapped if it is determined by the overlapping banknote determination module that the measurement result meets the preset banknote overlapping condition; and
a non-overlapping banknote module configured to determine that the to-be-recognized banknotes are not overlapped if it is determined by the overlapping banknote determination module that the measurement result does not meet the preset banknote overlapping condition.

8. The device according to claim 7, wherein the coupling degree measurement module comprises at least one of the following sub-modules:
a first sub-module, comprising:
a tone and structure texture unit configured to calculate a tone texture period and a structure texture period corresponding to a region of the transmission image defined by the local feature attribute window, wherein the tone texture period comprises the number of periodical color textures, the number of periods and a length of the period, and the structure texture period comprises the number of periodical structure texture features, the number of periods and a length of the period; and
a first determination unit configured to determine whether a difference between the tone texture period and a preset standard value corresponding to the local feature attribute window exceeds a first preset threshold and whether a difference between the structure texture period and the preset standard value corresponding to the local feature attribute window exceeds the first preset threshold, to obtain a first determination result;
a second sub-module, comprising:
a texton acquisition unit configured to acquire a texton corresponding to the region of the transmission image defined by the local feature attribute window, wherein the texton is a texture unit having a specific shape; and
a second determination unit configured to determine whether a difference between the texton and a predetermined standard texton corresponding to the local feature attribute window exceeds a second preset threshold, to obtain a second determination result; and
a third sub-module, comprising:
a texture definition acquisition unit configured to calculate a texture definition corresponding to the region of the transmission image defined by the local feature attribute window, wherein the texture definition indicates a blurring degree of a predetermined texture; and
a third determination unit configured to determine whether a difference between the texture definition and a preset standard value corresponding to the local feature attribute window exceeds a third preset threshold, to obtain a third determination result.

9. The device according to claim 8, wherein the overlapping banknote determination module comprises:
an overlapping banknote determination unit configured to determine whether any one of the first determination result, the second determination result and the third determination result is positive.

10. The device according to claim 9, further comprising at least one of the following module groups:
a first module group, comprising:
a front information module configured to acquire front denomination and orientation information of the to-be-recognized banknotes based on the front images;
a back information module configured to acquire back denomination and orientation information of the to-be-recognized banknotes based on the back images; and
a denomination and orientation determination module configured to determine whether the front denomination and orientation information is matched with the back denomination and orientation information according to a preset denomination and orientation rule, to obtain a fourth determination result;
a second module group, comprising:
a front size module configured to acquire front image sizes of the to-be-recognized banknotes based on the front images;
a back size module configured to acquire back image sizes of the to-be-recognized banknotes based on the back images; and
an image size determination module configured to determine whether the front image sizes or the back image sizes go beyond a preset standard size range of the to-be-recognized banknotes, to obtain a fifth determination result; and
a third module group, comprising:
a front light-transmittance module configured to acquire front light-transmittances of the to-be-recognized banknotes based on the front images;
a back light-transmittance module configured to acquire back light-transmittances of the to-be-recognized banknotes based on the back images; and
a light-transmittance determination module configured to determine whether the front light-transmittances or the back light-transmittances go beyond a preset standard light-transmittance range of the to-be-recognized banknotes, to obtain a sixth determination result.
